(19) United States
(12) Patent Application Publication
(10) Pub. No.: US 2007/0113175 A1
(43) Pub. Date: May 17, 2007

(54) METHOD OF PERFORMING LAYOUT OF CONTENTS AND APPARATUS FOR THE SAME

(76) Inventor: Shingo Iwasaki, Fujisawa-shi (JP)

Correspondence Address: MORGAN & FINNEGAN, L.L.P., 3 WORLD FINANCIAL CENTER, NEW YORK, NY, 10281-2101, US

(21) Appl. No.: 11/557,311

(22) Filed: Nov. 7, 2006

(30) Foreign Application Priority Data
Nov. 11, 2005 (JP) 2005-328084

(51) Int. Cl. G06F 17/00

(52) U.S. Cl. 715/517; 715/520

(57) ABSTRACT

A layout apparatus for laying out a plurality of contents determines the sizes of areas corresponding to respective contents that are required for accommodating the contents and lays out the areas corresponding to the respective contents. The layout apparatus adjusts the sizes of the areas corresponding to the respective contents on condition of the determined sizes so that the areas respectively corresponding to a plurality of contents do not overlap.

### BACKGROUND OF THE INVENTION

1. Field of the Invention

The present invention relates to a method of performing layout of contents and an apparatus for the same.

2. Description of the Related Art

When laying out contents such as images and text for use in a document within a certain area, a person can manually decide where to lay out individual contents utilizing a composing application and the like (U.S. Pat. No. 5,224,181).

There has also been a technique for evaluating contents layout that is done relying on human intuition or manual operations (US Publication No. 2003/86619).

However, when layout is manually performed due to absence of layout information that defines how to lay out contents in a document, a significant burden of trial and error is placed on an operator. When one creates a template that can output content data in a predetermined layout format and uses the template to lay out and output images and/or text, he can output only in several certain patterns. There has thus been a problem that it is impossible to obtain a result that flexibly lays out various content data considering their size and/or type of various content data input.

When a number of rectangle areas are laid out in a certain area and corresponding actual content data is subsequently rendered in each of them, problems as follows may occur. For example, for an image, by forcefully reducing the image to fit in the size of a rectangle area, the quality of the image can be degraded too much to make it less viewable. Or, although text data as content data is reduced to the smallest font size possible, all text may not fit in a rectangle area.

### SUMMARY OF THE INVENTION

The present invention intends to prevent degradation of contents when contents are laid out in a layout area.

An object of the present invention is to provide a method of performing a layout of a plurality of contents, comprising the steps of determining sizes of areas respectively corresponding to respective contents of the plurality of contents, said sizes being required for accommodating the respective contents, and performing a layout of the areas respectively corresponding to the respective contents, wherein said layout step includes a step of adjusting the sizes of the areas corresponding to the respective contents under condition of the determined sizes so that the areas respectively corresponding to the respective contents do not overlap.

Another object of the invention is to provide a layout apparatus for performing a layout of a plurality of contents, comprising determination means for determining sizes of areas respectively corresponding to respective contents of the plurality of contents, said sizes are required for accommodating the respective contents, and layout means for performing a layout of the areas corresponding to the respective contents, wherein said layout means adjusts the sizes of the areas respectively corresponding to the respective contents under condition of the determined sizes so that the areas corresponding to the respective contents do not overlap.

Further features of the present invention will become apparent from the following description of exemplary embodiments (with reference to the attached drawings).

### BRIEF DESCRIPTION OF THE DRAWINGS

FIG. 1A is a block diagram showing the concept of the overall configuration of processing in an embodiment;

FIG. 1B shows an example of rectangle information used in the embodiment;

FIG. 2 shows an exemplary hardware configuration of the layout apparatus of the embodiment;

FIG. 3 is a flowchart showing an example of layout procedure in the embodiment;

FIG. 4A is a block diagram showing an exemplary configuration of a rectangle layout processing unit 104 of FIG. 1A;

FIG. 4B is a flowchart showing an example of procedure in rectangle layout process (step S104) of FIG. 3;

FIG. 5 visually shows random positioning of rectangle areas;

FIG. 6 is a flowchart showing the procedure of overlap removal process (step S1044) of FIG. 4B;

FIG. 7 illustrates arrangement of a plurality of rectangle areas and removal of overlaps among them;

FIG. 8 generally illustrates how layout process is performed with combination of a weighting template indicating directionality of arrangement in layout and Simulated Annealing method;

FIG. 9 shows a specific example of a weighting template that indicates directionality of arrangement in layout that is used in the embodiment;

FIG. 10 illustrates an example of rectangle layout process S104;

FIG. 11 is a block diagram showing a configuration of the rendering and ill-fitting information compiling unit 108 of FIG. 1A;

FIG. 12 is a flowchart showing a procedure of rendering and ill-fitting information compiling process S108 of FIG. 3;

FIG. 13 shows an example of rendering and ill-fitting compiling process; and

FIG. 14 shows a result of layout and rendering in the embodiment.

### DESCRIPTION OF THE EMBODIMENTS

An embodiment of the present invention will be described in detail with reference to drawings. However, the invention is not limited by the embodiment.

In the embodiment, with inputted information of rectangle areas to be laid out and content data, the rectangle areas are laid out in a specified layout area and the content data is rendered in the laid out rectangle areas. If content data does not fit in a corresponding rectangle area, a reduction limit for the size of the rectangle area which can accommodate the content data is determined from the content data and layout of the rectangle areas is made again. In this manner, a rectangle area which can reliably accommodate intended contents is laid out in the specified layout area. This embodiment provides a method for performing appropriate layout considering both layout and rendering as well as an apparatus for the same. Consequently, disadvantages such as forceful reduction of image size and omission of text data can be eliminated and more appropriate result of layout and rendering of actual content data can be provided.

Although determination of a reduction limit size of a rectangle area in this embodiment is made when content data does not fit in a rectangle area, it may be performed beforehand prior to the initial layout process based on content data. In this embodiment, resolution of images and/or font size of text is separately set in respective rectangle areas. However, the same resolution and font size may be used in all rectangle areas or some rectangle areas that are grouped, or the resolution and font size may be common within a certain range. Alternatively, limitations may be provided for certain rectangle areas, e.g., they are not reduced. These embodiments are also included in the present invention.

<An Exemplary Configuration of a Layout Apparatus of the Embodiment>

(Concept Diagram Showing the Overall Configuration)

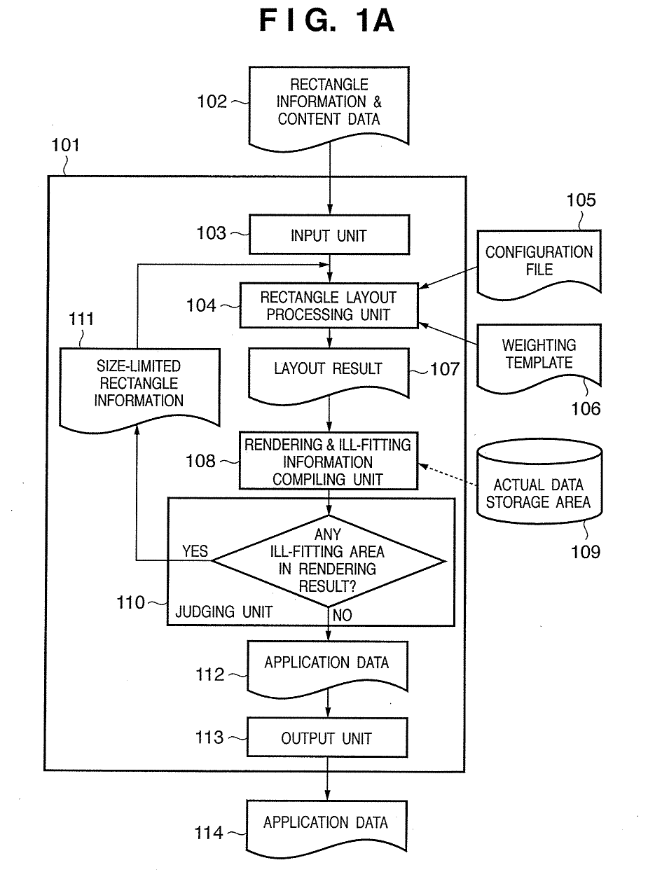

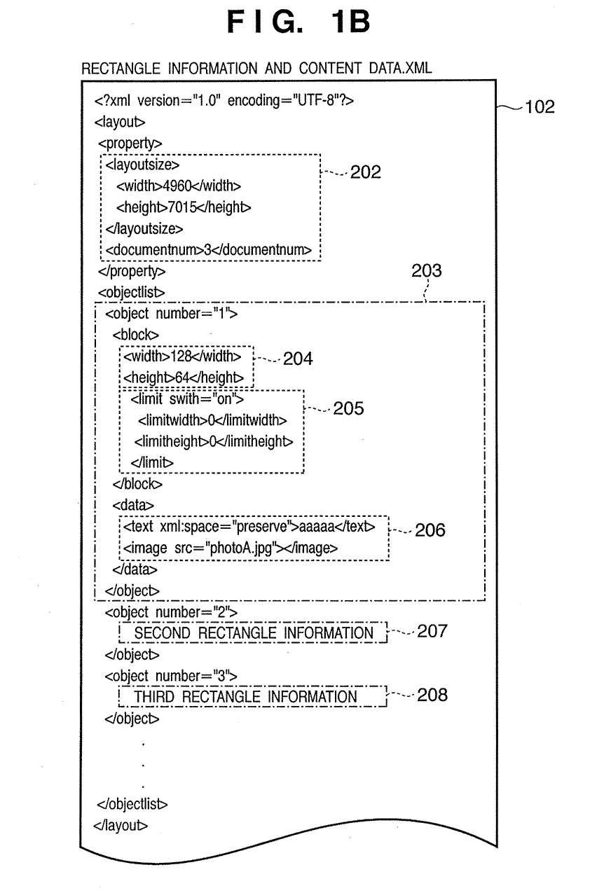

FIG. 1A is a block diagram conceptually showing the overall configuration of the layout apparatus of the embodiment. This layout apparatus is an apparatus for performing layout of a plurality of contents.

In FIG. 1A, reference numeral 101 denotes processing units in the layout apparatus. Reference numeral 102 denotes data that describes pieces of rectangle information and content data (e.g., including paths to image data and/or text data). The layout apparatus 101 receives the rectangle information and content data 102 at an input unit 103 to obtain data to be laid out. An example of the structure of rectangle information and content data 102 will be shown below with reference to FIG. 1B. Reference numeral 104 denotes a rectangle layout processing unit, which reads in a configuration file 105 which describes various setting information for controlling layout process and a weighting template 106 that indicates directionality of arrangement in layout. From these information and rectangle information received from the input unit 103, overlaps among rectangle areas are removed through enlarging/reducing of the rectangle areas and the rectangle areas are automatically arranged in a specified area according to an optimization algorithm. The result is compiled as a layout result 107 that describes positioning coordinates and/or sizes of the rectangle areas.

Reference numeral 108 denotes a rendering and ill-fitting information compiling unit. Initially, the layout result 107 and actual content data saved in an actual data storage area 109 are retrieved. They are used to render corresponding content data in the rectangle areas whose positioning has been determined by the rectangle layout processing unit 104. If the content data does not fit in a rectangle area, the size of an image is reduced if any image is in the content data and then font size of text data is reduced. The rendering and ill-fitting information compiling unit 108 repeats such reduction so that the content data fits in the rectangle area. However, if the rendering and ill-fitting information compiling unit 108 judges that the content data does fit in the rectangle area even after the content data is reduced to a predetermined reduction limit, it analyzes from the actual content data a rectangle size that can accommodate the content data and determines the reduction limit size of the rectangle area. The information is compiled as size-limited rectangle information 111.

In other words, the rendering and ill-fitting information compiling unit 108 determines the sizes of rectangle areas that are required for containing respectively corresponding contents them and outputs information of the determined sizes as size-limited rectangle information 111.

If a judging unit 110, which judges if there is any ill-fitting area in rendering result, determines that there is an ill-fitting area (i.e., content data cannot fit in a rectangle area), it passes size-limited rectangle information 111 to the rectangle layout processing unit 104. Upon receiving the size-limited rectangle information 111, the rectangle layout processing unit 104 re-lays out the rectangle areas so that layout process is completed without reducing a size of rectangle area with size limitation below its limit size (i.e., a rectangle size which can accommodate the content data). By repeating layout and rendering processes in this manner, content data can be rendered in a rectangle area reliably.

That is, the rectangle layout processing unit 104 lays out rectangle areas corresponding to respective contents. The rectangle layout processing unit 104 then adjusts the size of the rectangle areas corresponding to respective contents under condition of limit sizes so that the rectangle areas for the respective contents do not overlap.

However, it is afraid that layout cannot succeed as a result of re-layout with limitation on rectangle size. In such a case, priority among processes to be taken is determined in advance, such as reducing the number of content data, deleting a part of content data, and moving some data to another area (i.e., another page), and then the predetermined process is carried out.

When the judging unit 110 judges that content data has been rendered in a rectangle area without ill-fitting state, application data 112 output by the rendering and ill-fitting information compiling unit 108 is passed to an output unit 113, which then outputs the application data 112 as application data 114 as it is.

FIG. 1B shows an example of rectangle information and content data 102 in this embodiment. FIG. 1B is an example of rectangle information and content data 102 described in XML format (rectangle information and content data.xml).

As can be seen from FIG. 1B, in this example, rectangle information and content data is described between <layout> and </layout>. It mainly consists of <property> portion 202 and <objectlist> portion. The <objectlist> portion includes first rectangle information 203, second rectangle information 207, and third rectangle information 208.

The <property> portion 202 is a portion in which data on a layout area and the number of contents are set, being composed of <layoutsize> that represents a layout size (or the vertical and horizontal length of a layout area in which rectangle areas are laid out) and <documentnum> that represents the number of rectangle areas. Layout size is composed of data on the width of the layout area <width> (here, 4960) and data on the height of the layout area <height> (here, 7015). The number of rectangle areas <documentnum> of FIG. 1B shows a case where there are three rectangle areas.

The <objectlist> is a portion indicating the sizes of a plurality of rectangle areas to be laid out in the layout area and contents. The first rectangle information 203 between <objectnumber=“1”> and </object>, information required for the first rectangle area to be laid out in the layout area is provided.

The <block> portion has size information 204 indicating the vertical and horizontal sizes of a rectangle area. Here, data on the width of the rectangle area <width> is 128 and data on the height of the rectangle area <height> is 64.

The embodiment also has a <limit> element 205 that indicates limit values to which the vertical and horizontal sizes of a rectangle area can be reduced. Here, <limit switch=“ ”> is switch property for setting a flag that indicates whether the values are applied or not in layout. “On” represents to apply the values in layout, while “off” represents not to apply the values in layout. Data reduction limit for the width of a rectangle area is described in <limitwidth> and data reduction limit for the height of a rectangle area is described in <limitheight>. In FIG. 1B, no limit (i.e., zero) is set as an example in the initial layout.

In <data> 206, paths to text data and image data to be rendered in the rectangle area are described.

It is followed by pieces of data as many as rectangle areas (in the example of FIG. 1B, three), i.e., second rectangle information 207 and third rectangle information 208.

Although the example of FIG. 1B shows a structured document with XML data as a representation of rectangle information, the scope of the present invention is not limited to this. The rectangle information may also be represented as an HTML or SGML structured document or as simple text data.

(Exemplary Hardware Configuration of the Layout Apparatus According to the Embodiment)

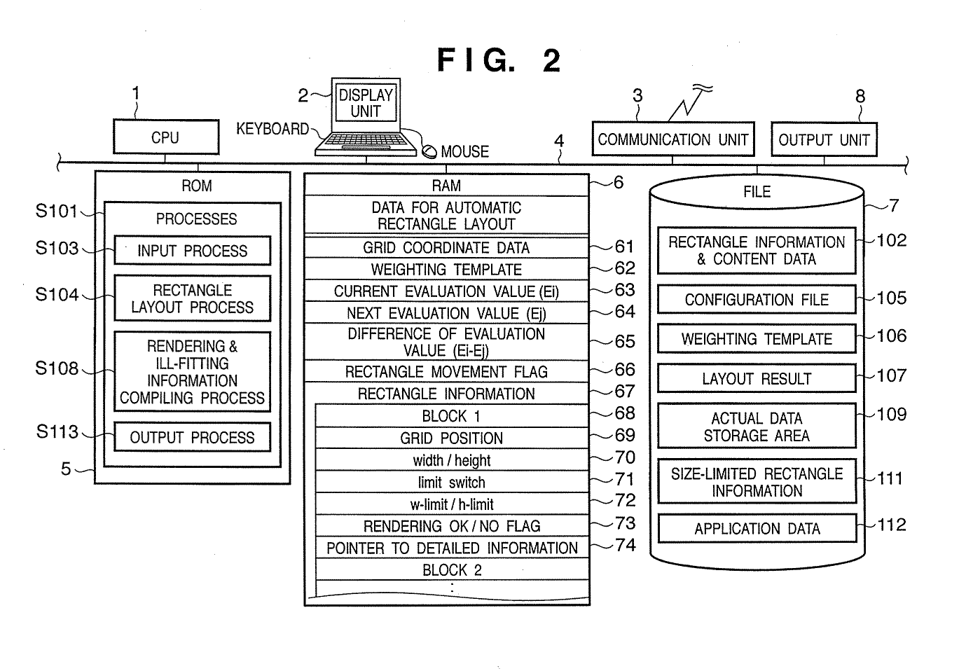

FIG. 2 shows an example of hardware configuration of a layout apparatus that implements processes in the embodiment shown in FIG. 1A. FIG. 2 only shows components necessary for description of the embodiment and omits other components.

Reference numeral 1 denotes a CPU for controlling processing of the entire apparatus. Reference numeral 2 denotes a display unit for an operator to give instructions to the apparatus or for indicating the apparatus status, including an operation unit such as a keyboard and/or mouse. Reference numeral 3 denotes a communication unit that is utilized for input and output communications. The communication unit 3 is also capable of receiving rectangle information and content data 102 and/or outputting layout result 107 and application data 114. Reference numeral 4 denotes a system bus that connects the CPU 1 to each of the units, including a data bus and a control bus.

Reference numeral 5 denotes ROM for storing stationary information for the apparatus. The ROM 5 may be a rewritable storage device such as flash memory or non-rewritable storage device. In this example, programs for realizing the processing units shown in FIG. 1A (denoted with adding “S” before the same reference numerals as FIG. 1A) are stored in the ROM 5. Other functions required for basic apparatus operations, such as OS or drivers for peripherals that are not significant for the description of the present embodiment, are not shown. Those programs may also be stored in a file 7, which will be discussed later, and loaded to RAM 6 to be executed by the CPU 1.

Reference numeral 6 denotes RAM that serves as a main storage device for use as a temporary storage. Although various data can be temporarily stored in the RAM 6 in accordance with program execution by the CPU 1, description here is limited to a case where data used for layout process of the embodiment is stored in the RAM 6. The data is used for the same purpose both in the initial layout of rectangle areas in a layout area and in the re-layout of rectangle areas with a determined limit size.

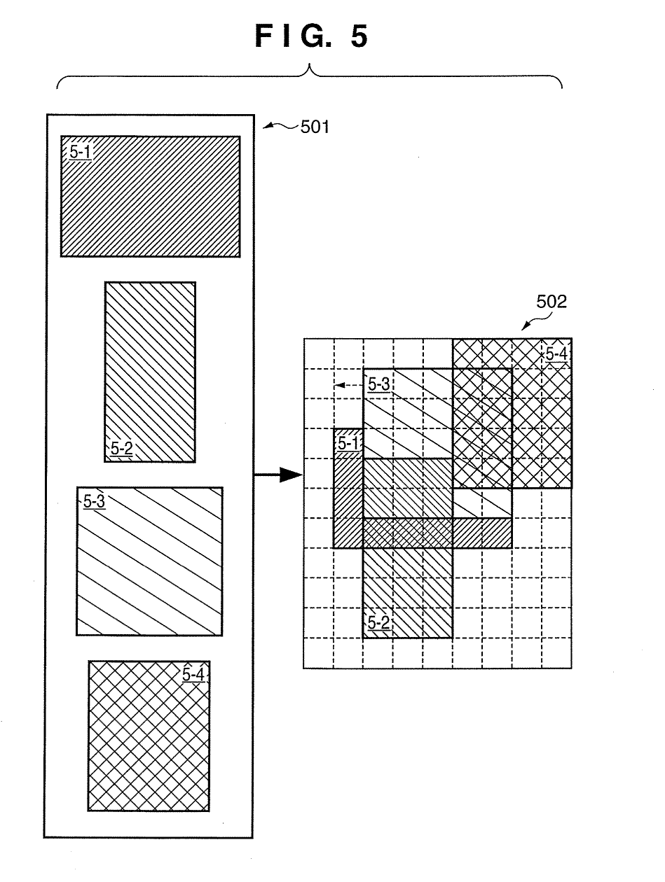

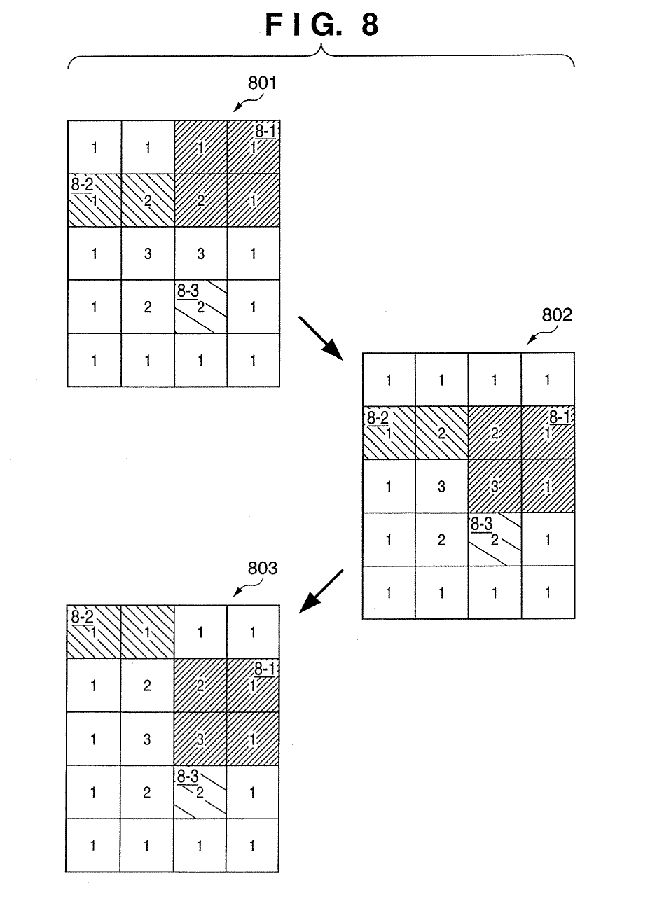

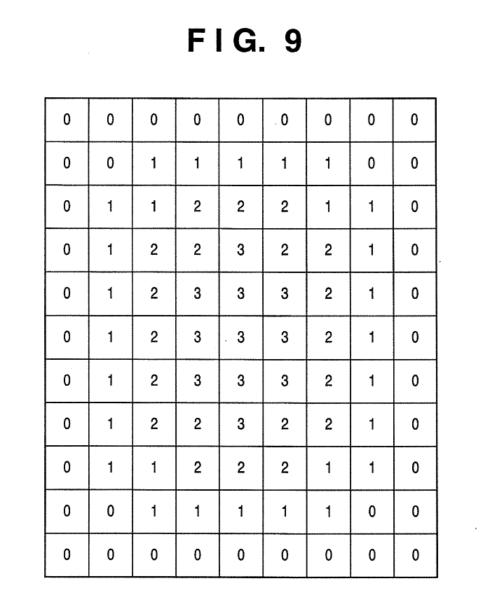

Reference numeral 61 denotes grid coordinate data indicating a grid onto which rectangle areas are automatically laid out (see the right figure in FIG. 5). Reference numeral 62 denotes a weighting template which weighs each square of the grid (see FIG. 9). Reference numerals 63 to 66 denote intermediate results that are calculated during execution of automatic layout in Simulated Annealing (referred as SA) method of the embodiment (SA method will be described below with reference to FIG. 8). Reference numeral 63 denotes a current evaluation value (Ei) that indicates current energy; 64 denotes a next evaluation value (Ej) indicating the next energy after arbitrary movement in of rectangle areas; 65 denotes the difference of evaluation value (Ei−Ej) between the current and next evaluation values for use in determination of whether to continue movement or not; and 66 denotes a rectangle movement flag that indicates whether to continue movement or not from an operation result of SA method.

Reference numeral 67 denotes rectangle information representing a rectangle area that is used in automatic layout of rectangle areas. The rectangle information 67 does not need to have all pieces of information shown in FIG. 1B. In this example, automatic layout can be executed when rectangle information 67 includes the following data for each block. For block 1 (68), a grid position 69, the width and height of the rectangle area 70, an execution flag for limitation on size reduction (limit switch) 71, a limit value for width reduction (w-limit) and a limit value for height reduction (h-limit) 72, and a rendering OK/NO flag 73 are prepared. The rendering OK/NO flag 73 indicates whether contents have fit in a rectangle area or not. The grid position 69 may be grid coordinates in the upper left corner, for example. Reference numeral 74 denotes a pointer to detailed information shown in FIG. 1B that is stored in the file 7. Subsequently, pieces of block information as many as rectangle areas to be laid out are stored.

Reference numeral 7 denotes a file which is stored in a device capable of bulk storage such as a hard disk and which stores therein information necessary for automatic layout of the embodiment. In the file 7, the various data files shown in FIG. 1A are illustrated with the same reference numerals. All of these data files need not be stored in the file 7 and some of data may be stored in the RAM 6. In a case programs are loaded into the RAM 6 for execution, the programs shown in the ROM 5 are also stored in the file 7.

Reference numeral 8 denotes an output unit for outputting layout results and/or information of a rectangle area that has failed to be laid out, which may include a printer, for example.

<An Exemplary Operation of the Layout Apparatus of the Embodiment>

An example of operation procedure showing how the layout apparatus having the configuration described above performs re-layout with reduction limit size of rectangle area will be described in sequence.

<Overall Procedure>

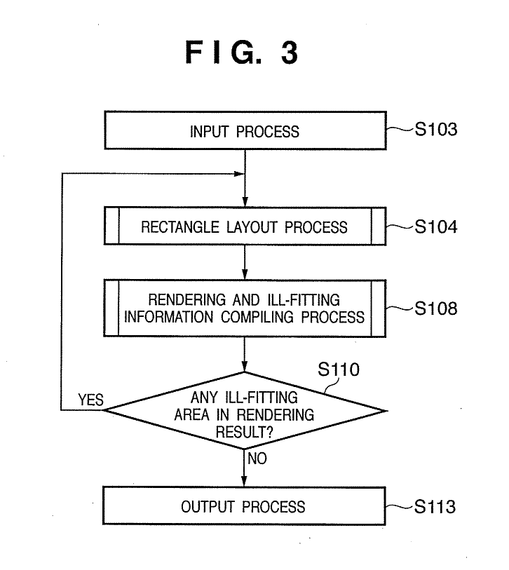

FIG. 3 is a flowchart showing the overall operation procedure of the embodiment. Reference numerals of steps in FIG. 3 correspond to each of the processing units of FIG. 1A and those processes of the ROM 5.

Step S103: Input Process

Rectangle information and content data 102 are input through the input unit 103. For example, they may be input as XML data from the Internet via the communication unit 3 and stored in the rectangle information and content data 102 in the file 7 (or RAM 6).

Step S104: Rectangle Layout Process

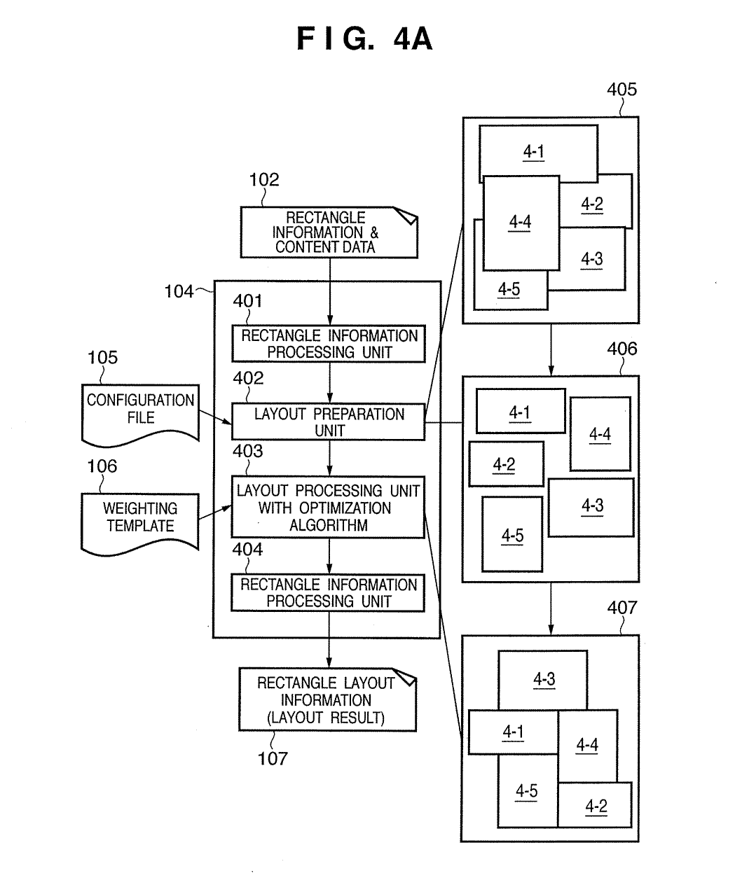

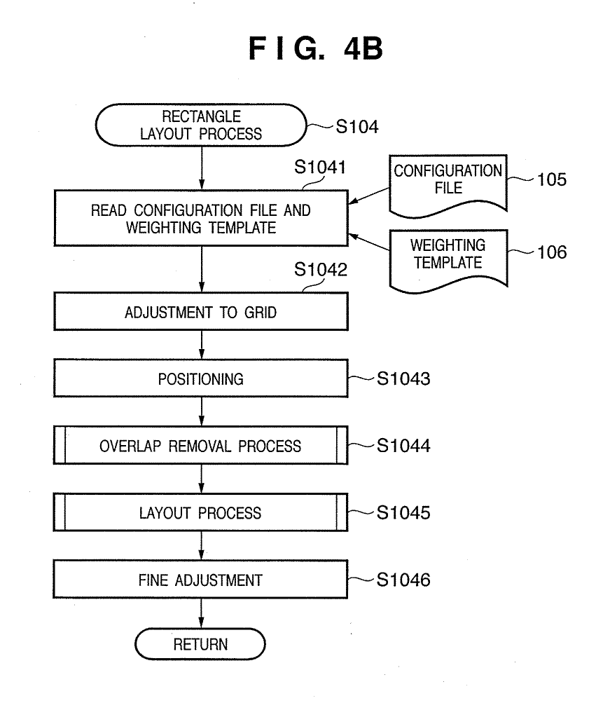

As will be described in more detail with respect to FIGS. 4A and 4B, rectangle areas are laid out in a layout area in accordance with rectangle information in the rectangle information and content data 102 input at step S103. During layout, reference is made to the configuration file 105 that contains data describing various information for controlling layout process and the weighting template 106 indicating the directionality of arrangement in layout.

Step S108: Rendering and Ill-Fitting Information Compiling Process

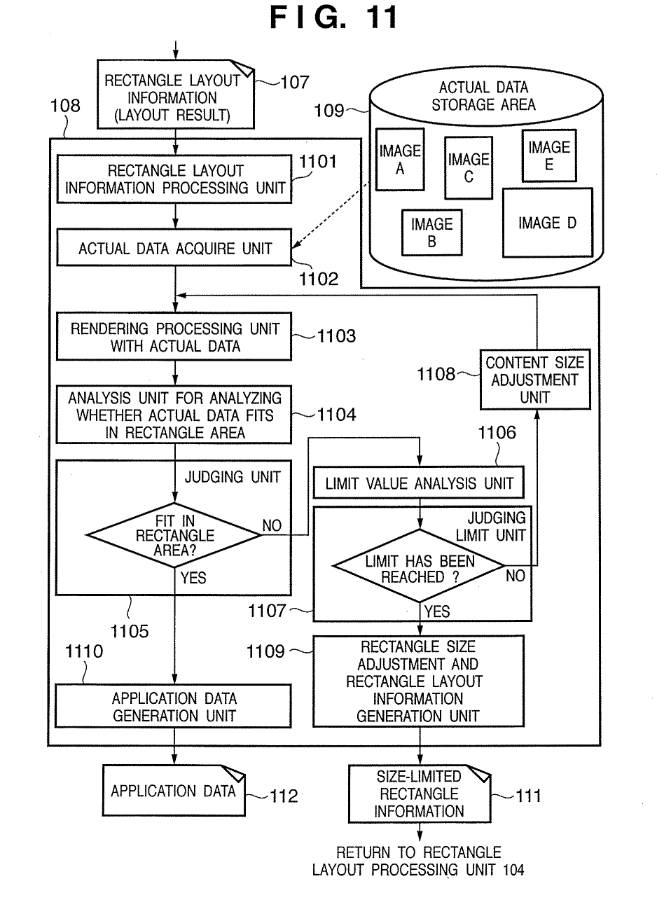

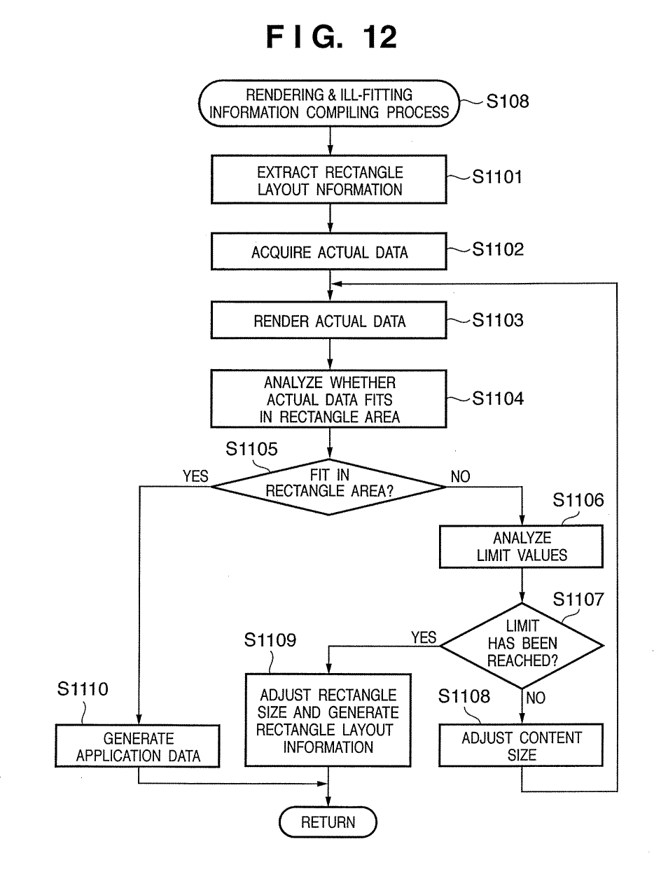

As will be described in more detail with respect to FIGS. 11 and 12, for each of the rectangle areas in a layout result 107 that have been laid out at step S104, actual content data stored in the actual data storage area 109 is retrieved and respective corresponding content data is rendered.

During the rendering of actual content data, when content data does not fit into a rectangle area as it is, the size of an image is reduced if any image is in the content data, and then if the content data still does not fit, font size of text data is reduced. Such reduction of image size and font size is repeated so that the content data fits in the rectangle area. If the content data still does not fit in the rectangle area even after it is reduced to a predetermined limit value of reduction, however, a rectangle size that can accommodate the actual content data is analyzed and determined. Then, information on the analyzed and determined rectangle size is compiled as information on size-limited rectangle information 111. In other words, at step S108, the sizes of the rectangle areas required for accommodating the respectively corresponding contents are determined and the sizes are output as size-limited rectangle information 111.

If the content data can be rendered in the rectangle areas, application data 112 which includes rendered content data in rectangle areas in layout result 107 is generated and output to the file 7 (or RAM 6), for example.

Step S110: Judgment of Presence of an Ill-Fitting Area in Rendering Result

When size-limited rectangle information 111 has been generated, that is, when there is a ill-fitting information in the result of rendering, the size-limited rectangle information 111 is passed to the rectangle layout processing unit 104, and the procedure returns to step S104. Upon receiving the size-limited rectangle information 111, the rectangle layout processing unit 104 again lays out the rectangle areas so that layout process is completed without reducing a rectangle area with size limitation below the limit size. In such a manner, layout and rendering processes are repeated so that content data can be rendered in the rectangle areas.

That is, at step S104, rectangle areas corresponding to respective contents are laid out. At step S104, the sizes of the rectangle areas for the contents are also adjusted under condition of the limit sizes determined at step S108 such that the rectangle areas do not overlap.

To be more specific, when the contents do not fit in corresponding rectangle areas laid out in the initial layout, the sizes of the rectangle areas necessary for accommodating the contents are determined at step S108. Then, in execution of the second layout, the sizes of the rectangle areas for the contents are adjusted under condition of the limit sizes determined at step S108 such that the rectangle areas corresponding to the contents do not overlap.

It is afraid that layout cannot be succeed as a result of re-layout with limitation on rectangle size. In that case, priorities among processes to be taken may be determined in advance and the predetermined process can be carried out, such as (1) to reduce the number of content data, (2) to delete a part of content data, and (3) to move data to another area (or another page).

S113: Output Process

If it is determined that there is no ill-fitting information in the rendering result at judgment of presence of a ill-fitting area in rendering result (S110), a layout result 107 (result of layout such as information of the coordinates on which the rectangle areas are positioned and their vertical and horizontal sizes) is compiled for each of the rectangle areas. Then, the layout result 107 may be output as application data 112 to the file 7 or application data 112 may be output as application data 114 as required, and all layout and rendering process is completed.

At step S113, application data 114 is printed out as hard copy via the output unit 8 or output over a communication line by way of the communication unit 3. It is also possible to output the application data 114 onto a network including the Internet by the communication unit 3. The layout result 107 can be output as XML data described in XML.

<Detailed Processing by Each of the Processing Units and Specific Examples>

Processing by the characteristic processing units of the embodiment will be described in detail below with reference to a specific example.

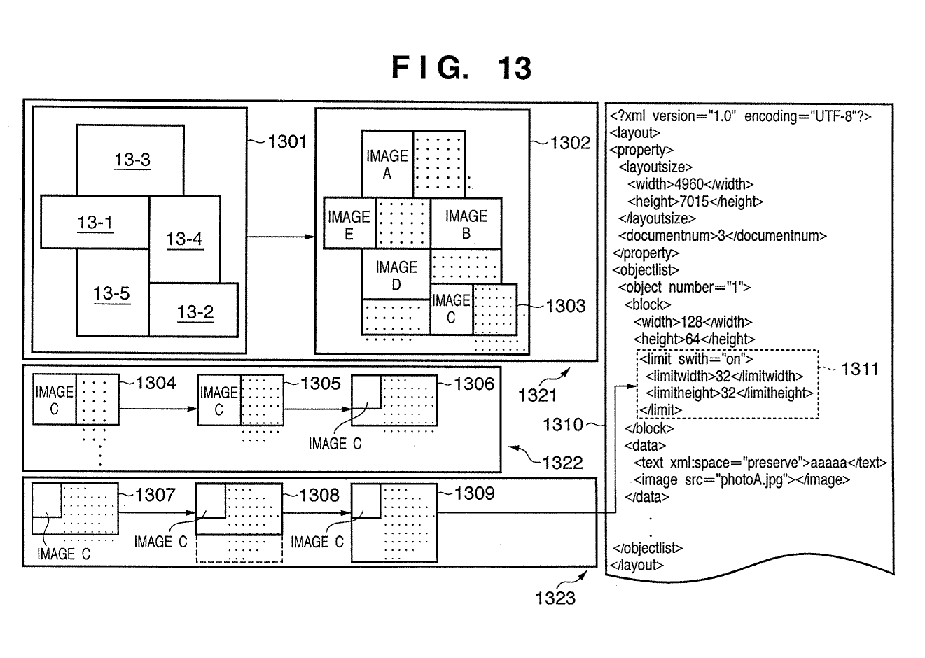

In this example, an example of a rectangle area defined by rectangle information input to the input unit 103 is shown in FIG. 4A or FIG. 13. Reference numeral 501 in FIG. 5 shows a case of a document that includes rectangle areas 5-1, 5-2, 5-3 and 5-4 to be laid out that respectively correspond to images and/or text, for the purpose of describing automatic layout of rectangle areas.

<Rectangle Layout Processing Unit 104: S104>

(An Exemplary Configuration of the Rectangle Layout Processing Unit 104)

FIG. 4A shows an example of more detailed processing at the rectangle layout processing unit 104 shown in FIG. 1A. The detailed configuration of the rectangle layout processing unit 104 includes a rectangle information processing unit 401, a layout preparation unit 402, layout processing unit with optimization algorithm 403, and a rectangle information processing unit 404. Here, rectangle information and content data 102 is rectangle information and content data.xml that represents the rectangle information and content data shown in FIG. 1B in XML format as mentioned above.

The rectangle information processing unit 401 extracts the size information 204 for rectangle areas to be laid out in a determined layout area from rectangle information and content data 102 (rectangle information and content data.xml) that is input as XML data.

The layout preparation unit 402 performs preliminary layout process for layout process with an optimization algorithm in a manner described below with reference to the configuration file 105 in which information necessary for layout is described.

Positioning: as shown at reference numeral 405 in the example of randomly positioning rectangle areas in a specified area in layout process, the rectangle areas 4-1 to 4-5 are first positioned randomly in a specified area from information of rectangle area size retrieved.

Removal of overlap: subsequently, as shown at 406, by rearranging the randomly positioned rectangle areas or reducing the size of the rectangle areas, overlaps among the rectangle areas are removed. Here, if limit values of reduction (205) are specified for the rectangle areas and an instruction to enable the values is described in rectangle information at the time of reduction, overlaps are removed in such a manner that the sizes of the rectangle areas are not reduced below the limit values.

The layout processing unit with optimization algorithm 403 references an optimization algorithm such as a genetic algorithm and Simulated Annealing method as well as weighting template 106 that indicates directionality of arrangement in layout. As shown in the example of centering algorithm at reference numeral 407, when centering algorithm is specified, for example, an optimal layout is derived in which rectangle areas are clustered in the center without space and do not lie off the specified layout area.

While the example of centering algorithm is given in this embodiment, the present invention is not limited to the centering algorithm. Rather, in addition to centering algorithm, various layout policies can be determined with the weighting template 106. The layout processing can be made in accordance with the weighting template, e.g., to arrange rectangle areas around a certain area with a space at the center or to arrange rectangle areas from upper left sequentially.

When an optimal layout result is obtained at the layout processing unit with optimization algorithm 403, the rectangle information processing unit 404 formats and outputs the result as rectangle layout information (or a layout result in FIG. 1A) 107. This formatting includes fine adjustment of the rectangle areas, for example.

(An Exemplary Procedure of Rectangle Layout Process S104)

Processing at the rectangle layout processing unit 104 will be described with respect to the flowchart of FIG. 4B.

The configuration file 105 which describes various setting information for controlling layout and the weighting template 106 that indicates directionality of arrangement in layout are read from the file 7, for example, and then the initial settings required for controlling layout of rectangle information are made (S1041). If necessary, each of the rectangle areas is adjusted to a size which enables its vertical and horizontal sizes to be divided by the width of a specified division area (i.e., square in grid), such as by way of enlarging (S1042). As shown by 501 of FIG. 5, this embodiment provides rectangle areas of sizes that are already adjusted or that can be divided by the grid width.

Next, the rectangle areas indication in grid form is randomly positioned (S1043). This positioning is made such that the rectangle areas do not lie off the layout area indicated in grid form. This processing is shown in FIG. 5, where these rectangle areas in grid form are randomly positioned in a layout area divided in grid form such that the four corners of a rectangle area are positioned on any corner of one square in grid as shown by 502 in FIG. 5. At this point, the rectangle areas may overlap with each other.

(Overlap Removal Process: S1044)

Removal of overlap is performed to remove overlapping portions by moving the rectangle areas according to a certain rule or reducing their size if required (S1044).

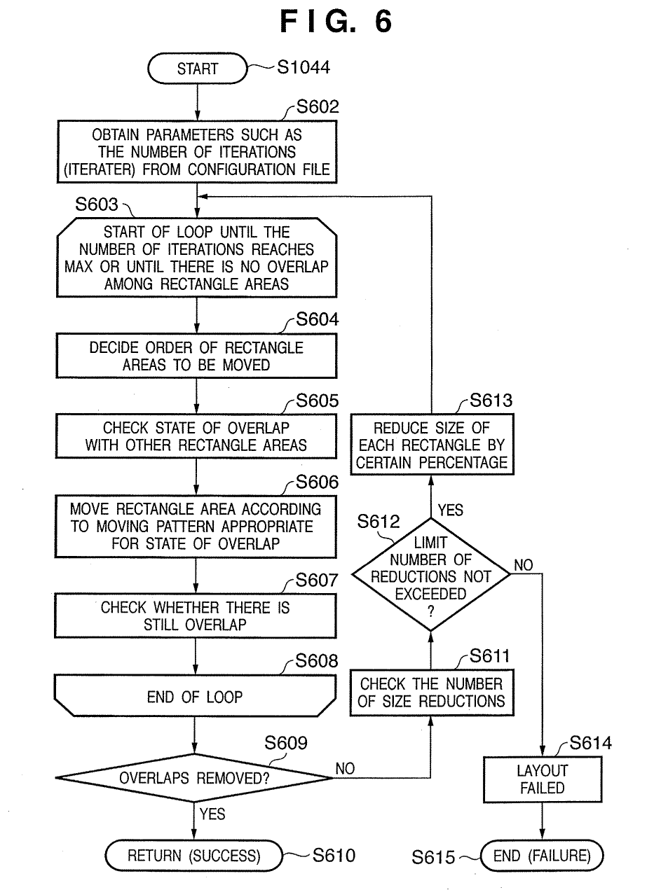

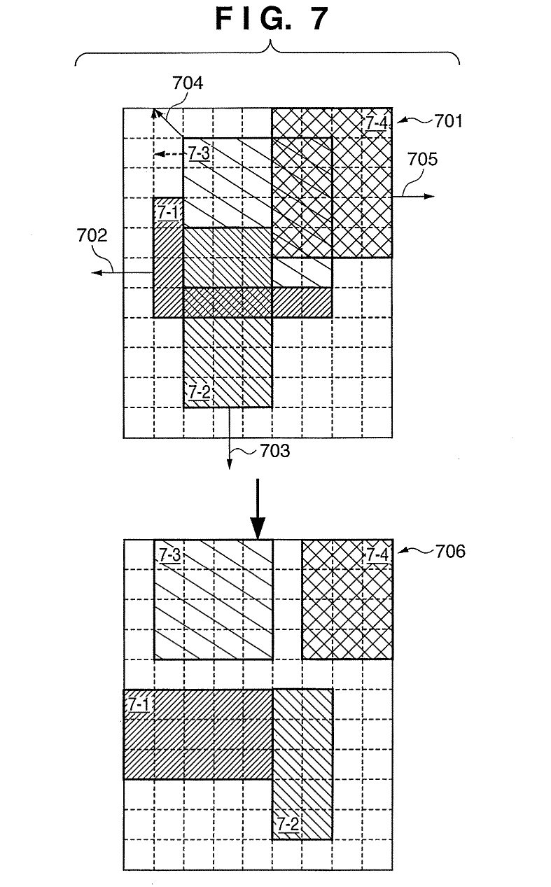

The overlap removal process (S1044) will be described below in detail. FIG. 6 is a flowchart showing an exemplary procedure of overlap removal, and FIG. 7 visually shows a process of overlap removal with respect to elimination of overlap among rectangle areas. Specifics of overlap removal process will be described with FIGS. 6 and 7. Note: rectangle areas 7-1 to 7-4 in FIG. 7 correspond to rectangle areas 5-1 to 5-4 in FIG. 5.

First, at step S602, various setting information for controlling layout process, e.g., set values such as the number of iterations (the upper limit (Max) of a parameter (so-called as Iterater) for controlling the number of loops) and the number of size reductions, is retrieved from the configuration file 105.

At step S603, loop of overlap removal is started. Processes up to step S608 are repeated until the parameter (Iterater) for controlling the number of loops reaches the upper limit (Max) set as the number of iterations or until there is no overlap among the rectangle areas.

At step S604, the order of moving rectangle areas among the rectangle areas is determined (e.g., among the rectangle areas 5-1 through 5-4 included in document 501 of FIG. 5). At step S605, the state in which a target rectangle area to be moved overlaps other rectangle areas is checked in accordance with the order determined at the step S604. At step S606, the target rectangle area is moved in accordance with a movement pattern appropriate for the state in which the target rectangle area overlaps other rectangle areas.

At step S607, it is checked whether there is still any overlap among the rectangle areas after the target rectangle area is moved (i.e., whether there is left any overlap among rectangle areas other than the moved target rectangle area). At step S608, it is judged whether overlaps among rectangle areas can be removed and whether the number of loops has exceeded the upper limit number of iterations. That is, overlaps among rectangle areas must be removed within the upper limit number of iterations that has been set. For example, after rectangle area 7-1 is first selected as the target for movement and overlaps associated with rectangle area 7-1 are removed, presence of overlaps is sequentially judged for remaining rectangle areas 7-2 to 7-4 sequentially. If there is an overlap, a rectangle area currently selected as the target for movement is moved in the layout area one by one so that overlapping areas are removed as a whole.

At step S609, it is judged whether all overlaps among rectangle areas have been removed. If there is no overlap any more (Yes at S609), the procedure proceeds to step S610, where processing associated with overlap removal is terminated. However, if it is judged at step S609 that all overlaps among rectangle areas have not been removed (No at S609), the procedure proceeds to step S611.

When overlaps among rectangle areas failed to be removed (for example, the upper limit number of iterations has been exceeded by the number of loops), the number of size reductions is checked at step S611. If the number of size reductions has not exceed the upper limit number of size reductions at step S612 (Yes at S612), the procedure proceeds to step S613, where the sizes of the rectangle areas are reduced by a certain ratio given by the configuration file 105. If there is specification (205) of reduction limit values for the rectangle areas and an instruction to enable the reduction limit values is indicated in rectangle information, overlaps must be removed while not reducing the sizes of the rectangle areas below the limit values. The procedure then returns to step S603, where overlap removal loop is again started.

However, if the number of reductions exceed over the upper limit number of reductions (No at S612), the procedure proceeds to step S614. At step S614, it is determined that all overlaps among rectangle areas cannot be removed with the number of reductions and the number of overlap removal loops that have been set, and failure in layout is notified. The procedure is terminated at step S615.

FIG. 7 illustrates arrangement of a plurality of rectangle areas and removal of overlaps among the rectangle areas.

A state is shown by 701 of FIG. 7, in which a plurality of rectangle areas are positioned in a layout area through positioning process (which corresponds to 502 of FIG. 5). In view of overlapping relations among the rectangle areas, the rectangle areas 7-1 to 7-4 are respectively moved in the directions of arrows 702 to 705 and reduced in size (reduced by one square in grid both vertically and horizontally). As a result, a state is provided in which all overlaps have been finally removed in arrangement of the reduced rectangle areas as shown by 706 of FIG. 7.

(Layout Process: S1045)

After overlaps have been removed at overlap removal process (S1044), layout process based on an optimal algorithm method is performed (S1045). In layout process, the rectangle areas are optimally arranged in the layout area in accordance with the weighting template that indicates the directionality of arrangement in layout. Layout process based on an optimal algorithm method will be described below with reference FIGS. 8, 9 and 10.

Simulated Annealing method (herein “SA method”) can be utilized as an optimal algorithm method for layout process. Although detailed description on SA method will be omitted, it is a method for solving combinational optimization problem.

An example of the method is that “the temperature of a solid is increased until the solid has sufficient free energy, and while the solid is subsequently cooled with its temperature being controlled, its free energy is minimized through a certain procedure.” Assume that a solid S has energy Ei when current state Si of the solid S is given. By randomly selecting particles and moving the selected particles by a random amount, the next state Sj of the solid S that has energy Ej is generated. When energy Ei in the current state is equal to or smaller than energy Ej in the next state, that is, when
ΔE=Ei−Ej≦0 (1)
the movement is adopted so that Sj becomes the current state.

On the other hand, if energy Ei in the current state is greater than energy Ej in the next state, that is, when
ΔE=Ei−Ej>0 (2)
whether to move the particles is determined probabilistically based on Formula (3) below.
Prob=e^{-(ΔE/(KB·T)} (3)
where KB represents a Boltzmann constant and T represents temperature.

In this case, the criterion for deciding whether to move particles is known as Metropolis Algorithm that is based on an enormous number of iterations. This entire method of solution is called SA method. In layout process of the embodiment, this SA method is applied to control layout of rectangle areas.

FIG. 8 generally illustrates how a layout process is performed with combination of the weighting template 106 that indicates directionality of arrangement in layout and SA method. Although four rectangle areas are laid out in a 9×9 grid in this example, for the sake of brevity, FIG. 8 illustrates layout of three rectangle areas in a 4×4 grid. It will be known by a example in FIG. 8 that the SA method can be applied to a general layout process.

At 801 of FIG. 8, there is a grid of a layout area on which three rectangle areas 8-1 to 8-3 are arranged. The sum of weighting values that are assigned to squares of the grid on which each rectangle area is positioned, is handled as an evaluation value.
Rectangle area 8-1: 1+1+2+1=5 (4)
Rectangle area 8-2: 1+2=3 (5)
Rectangle area 8-3: 2 (6)
In this case, the evaluation value for the all three rectangle areas is determined as Formula (7):
(5+3+2)×10=100 (7)
In Formula (7), in order to handle an evaluation value 1 as 10 points, the sum of evaluation values (4) to (6) is multiplied by 10.

Determining evaluation values with rectangle area 8-1 being moved in a random direction, e.g., positioned as shown at 802 of FIG. 8, results are as Formulas (8) to (11):
Rectangle area 8-1: 2+1+3+1=7 (8)
Rectangle area 8-2: 1+2=3 (9)
Rectangle area 8-3: 2 (10)
In this case, the evaluation value for all three rectangle areas is determined as Formula (11):
(7+3+2)×10=120 (11)

Since the new evaluation value (120: Formula (11)) after movement of rectangle area 8-1 is greater than the previous evaluation value (100: Formula (7)), the value by Formula (11) is adopted based on the relation of Formula (1). In other words, the position of the rectangle area 8-1 is adopted as the position after movement (i.e., the position shown at 802 of FIG. 8 for which the new evaluation value is determined) and therefore, the rectangle area 8-1 is arranged as shown at 802.

Next, determining evaluation values with the rectangle area 8-2 being moved in a random direction, e.g., positioned as shown at 803 of FIG. 8, results are as Formulas (12) to (14) below:
Rectangle area 8-1: 2+1+3+1=7 (12)
Rectangle area 8-2: 1+1=2 (13)
Rectangle area 8-3: 2 (14)
In this case, the evaluation value for all three rectangle areas is determined as Formula (15).
(7+2+2)×10=110 (15)

Since the new evaluation value after the movement of rectangle area 8-2 (110: Formula (15)) is smaller than the previous evaluation value (120: Formula (11)), the layout processing unit 403 decides to adopt the movement of rectangle area 8-2 probabilistically according to Formula (3) based on the relation of Formula (2).

Assuming that the current temperature is 100° C. and Boltzmann coefficient is 1,
ΔE=Ei−Ej=120−110=10 (16)
Prob=e^{-(ΔE/(KB·T))}=0.9048 (17)

In addition, aside from these calculations, a random value as Boltzmann coefficient is extracted between 0 and 1. If 0.6 is determined, for example, since 0.6<P(=0.9048), the position after movement (i.e., the position at 803 of FIG. 8 for which the new evaluation value is obtained) is adopted as the position of the rectangle area 8-2 and therefore, the rectangle area 8-2 is arranged as shown at 803.

Reversely, if the randomly extracted value is 0.95, 0.95>P(=0.9048). In this case, the layout processing unit with optimization algorithm 403 does not adopt the movement of the rectangle area 8-2 according to a probabilistic determination method based on Formula (3). Therefore, the position of the rectangle area 8-2 remains as shown at 802 of FIG. 8.

As to the current temperature, it is preferable to determine the current temperature by which the result of calculation of Prob is not biased too much, tentatively in advance with balance to the evaluation value (10 points relative to value 1). Although the calculation illustrated above assumes a temperature of 100° C., the scope of the present invention is not limited to the temperature.

In a layout process, an evaluation value for overall layout is determined based on the positions of the rectangle areas and weighting values, and the rectangle areas are laid out at optimal positions in accordance with relations among evaluation values (e.g., Formulas (1) to (3)).

FIG. 9 illustrates an example of a weighting template in the 9×9 grid in this example that directs the four rectangle areas at 706 of FIG. 7 to be gathered toward the center without space among the four rectangle areas.

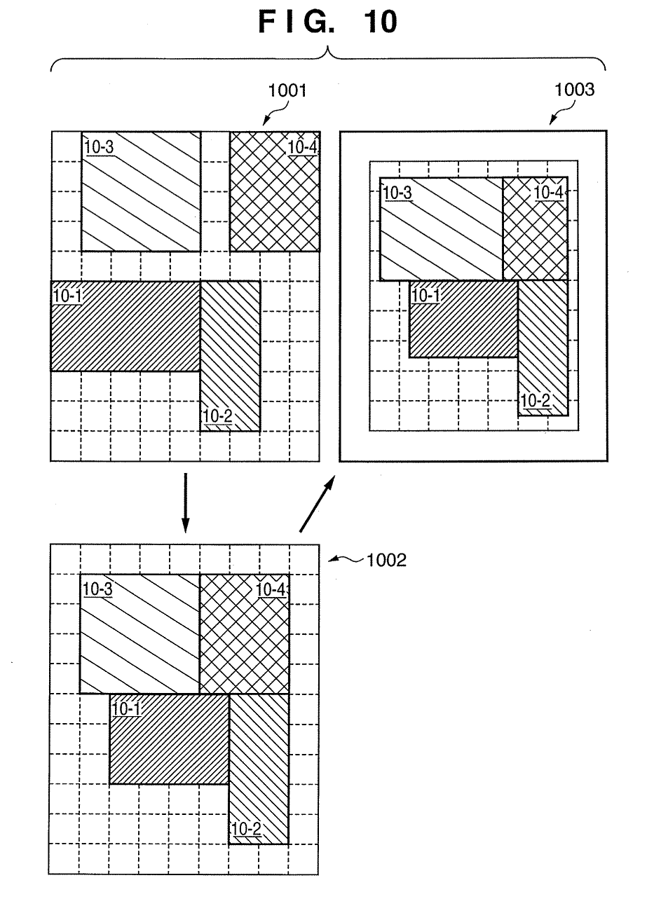

FIG. 10 illustrates a layout process with SA method in a case there is no overlap among rectangle areas.

A state is shown at 1001 of FIG. 10, in which the rectangle areas 10-1 to 10-4 are randomly positioned in the layout area (which corresponds to 706 of FIG. 7). A result of layout in SA method by the layout processing unit with optimization algorithm 403 is shown at 1002 of FIG. 10. The rectangle areas are laid out being gathered toward the center without space among the rectangle areas, at 1002 of FIG. 10.

(Fine Adjustment: S1046)

Layout at layout process (S1045) is followed by a process for removing spaces among the rectangle areas, which spaces are formed by putting the vertical and horizontal sizes of the rectangle areas positioned on squares of grid back to sizes corresponding with the aspect ratio of the original images (S1046).
(1) Put the sizes of the rectangle areas back to sizes that maintain the aspect ratio before the rectangle areas are positioned on squares of grid.
(2) As spaces are formed between the put-back rectangle areas, remove the spaces.
Spaces are removed in the following manner:
   (2-1) Determine the distance between the center of the layout area and the center of the respective rectangle areas.
   (2-2) Move first rectangle area that is closest to the center of layout area toward a rectangle area that is closest to the first rectangle area until the both sides of the first and closest rectangle areas come into contact.
   (2-3) Move second rectangle area that is second closest to the center of layout area toward a rectangle area closest to the second rectangle area until the both sides of the second and closest rectangle areas come into contact.
   (2-4) If a target rectangle area to be moved cannot be moved because the target rectangle area is in contact with other two rectangle areas at two sides, move a rectangle area whose center is farthest from the center of the layout area so as to obtain a layout result which has no space among all rectangle areas.
A result of applying such fine adjustment to 1002 of FIG. 10 is shown at 1003 of FIG. 10. Further details on the layout process can be found in US Publication No. 2006/112330.

<Rendering and Ill-Fitting Information Compiling Unit 108: S108>

(An Exemplary Configuration of the Rendering and Ill-Fitting Information Compiling Unit 108)

FIG. 11 shows an example of more detailed configuration of the rendering and ill-fitting information compiling unit 108 shown in FIG. 1A. A specific example of rendering and ill-fitting information compiling process in this embodiment is visually illustrated in FIG. 13. Rectangle layout information 107 of FIG. 11 corresponds to a layout result 107 that is output as a result of processing at the rectangle layout processing unit 104 of FIG. 1A.

Hereinafter, units comprised in the rendering and ill-fitting information compiling unit 108 will be described in detail.

A rectangle layout information processing unit 1101 extracts information for content data to be rendered in rectangle areas from rectangle layout information, that is, information in the layout result 107 provided from the rectangle layout processing unit 104. An actual data acquire unit 1102 retrieves and acquires actual image data from the actual data storage area 109 when there is a path to image data in content data. A rendering processing unit with actual data 1103 renders image data and text data in each of the rectangle areas (see 13-1 to 13-5 in FIG. 13) whose layout have been determined based on the rectangle layout result 1301 of FIG. 13. The result of rendering may be shown as rendering result 1302 in 1321 of FIG. 13, for example. Although the present example refers to a case where images fit in rectangle areas, if any image cannot fit in a rectangle area even after the size of the image is reduced to a reduction limit size at which image degradation is not visible.

An analysis unit 1104 for analyzing whether actual data fits in rectangle areas judges whether content data fits in each of the rectangle areas and finds an example of result 1303, where text data overflows a rectangle area such as shown at 1321 of FIG. 13. If it is indicated in the result of analysis by the analysis unit 1104 for analyzing whether actual data fits in a rectangle area that the data does not fit in the rectangle area, a judging unit 1105 passes control to a limit value analysis unit 1106. If it is determined at the analysis unit 1104 that all content data fit in the rectangle areas, the procedure proceeds to processing at an application data generation unit 1110.

The limit value analysis unit 1106 judges whether the font size of text data has not reached a reduction limit value or whether resolution of images has not reached a reduction limit value. If the limit value analysis unit 1106 determines that either one has not reached the reduction limit value, a judging limit unit 1107 passes control to a content size adjustment unit 1108. However, if it is determined at the limit value analysis unit 1106 that both text and images have reached the reduction limit values, the procedure proceeds to a rectangle size adjustment and rectangle layout information generation unit 1109.

The content size adjustment unit 1108 makes reduction of content size and has the rendering processing unit with actual data 1103 repeat rendering the content data. A specific example of this process is shown at 1322 of FIG. 13. If text data overflows a rectangle area as shown at 1304, the text data is rendered with the reduced font size reduced as shown at 1305. If the text data still does not fit in the rectangle area with the smallest font size, rendering is attempted with the reduced size of the image as shown at 1306.

The rectangle size adjustment and rectangle layout information generation unit 1109 performs a process, when content data does not fit in a rectangle area even if both images and text are rendered at reduction limit values by the content size adjustment unit 1108 as shown at 1307 in 1323 of FIG. 13. In this process, a size of rectangle area that can accommodate the content is calculated, e.g., from the number of remaining characters of text data as shown at 1308 (as indicated in the dotted box at the bottom). Then, the rectangle size adjustment and rectangle layout information generation unit 1109 sets the calculated size of rectangle area shown at 1309, in the portion indicated by 1311 in rectangle information and content data.xml as shown at 1310. In other words, the rectangle size adjustment and rectangle layout information generation unit 1109 adds the size to <limitwidth> and <limitheight> as reduction limit values and sets switch property of <limit> ON as a flag for enabling the limit values. The rectangle size adjustment and rectangle layout information generation unit 1109 outputs rectangle information with the reduction limit values as the size-limited rectangle information 111 shown in FIG. 11. The size-limited rectangle information 111 is rectangle information and content data 102 input from the input unit 103 plus the reduction limit values 1311.

That is, the rectangle size adjustment and rectangle layout information generation unit 1109 determines the sizes of rectangle areas corresponding to the respective contents that are required for accommodating the contents. Then, the rectangle size adjustment and rectangle layout information generation unit 1109 writes the determined sizes (or reduction limit values) in a structured document which describes a plurality of contents (or rectangle information and content data.xml) for respective contents.

The size-limited rectangle information 111 is passed to the rectangle layout processing unit 104 of FIG. 1A, which lays out the rectangle areas again. In this re-layout, if there are reduction limit values for the rectangle areas (205 or 1311) and an instruction to enable the reduction limit values described in rectangle information when reducing the size of the rectangle areas for the purpose of removing overlaps among the rectangle areas, the rectangle areas are not reduced below the reduction limit values. In other words, the rectangle layout processing unit 104 adjusts the size of rectangle areas corresponding to the respective contents under condition of the reduction limit values so that rectangle areas for respective contents do not overlap. The rectangle layout processing unit 104 adjusts the sizes of rectangle areas corresponding to respective contents described in rectangle information and content data.xml under condition of sizes (or reduction limit values) written in rectangle information and content data.xml for respective contents.

Consequently, for a rectangle area that has overflowing contents as shown at 1303 in 1321 of FIG. 13, a size of rectangle area that can accommodate the contents is secured and the rectangle area is laid out in the layout area, and the laid out rectangle area is subjected to rendering process again.

The application data generation unit 1110 converts the final rendering result, i.e., the final layout result 107, to application data 112 such as in PDF and then outputs the application data 112.

(An Example of Rendering and Ill-Fitting Information Compiling Process S108)

Rendering and ill-fitting information compiling process made at step S108 of FIG. 3 will be described in detail with the flowchart of FIG. 12.

Step S1101: Extract Rectangle Layout Information

From information in the layout result 107, which is output of rectangle layout process at step S104 of FIG. 3, information for content data to be rendered in the rectangle areas is extracted.

Step S1102: Acquire Actual Data

When there is a path to image data or text data as content data, the actual image or text data is retrieved and acquired from the actual data storage area 109.

Step S1103: Render Actual Data

In each rectangle area in the layout result 107, corresponding image data and text data are rendered. In the rendering process, first, if the vertical size of an image is greater than the horizontal size, the size of the image is reduced with maintaining aspect ratio so that vertical size of the image fits in the vertical size of the rectangle area, while if the horizontal size is greater than the vertical size, the image is reduced with maintaining the aspect ratio such that horizontal size of the image fits in the horizontal size of the rectangle area. In this manner, processing for fitting image data into a rectangle area is carried out. Thereafter, corresponding text data is embedded into a remaining area of the rectangle area in which no image data is embedded.

Step S1104: Analyze Whether Actual Data Fits in the Rectangle Area

Analysis is made as to whether content data fits in each of the rectangle areas, for example, whether text data overflows the rectangle areas or not.

Step S1105: Judge Whether Content Data Fits in the Rectangle Area

If it is judged that the actual content data does not fit in the rectangle area at analysis at step S1104, the procedure branches to step S1106, while if it is judged that all content data fits in the rectangle areas, the procedure branches to step S1110.

Step S1106: Analyze Limit Values

Analysis is made as to whether the font size of text data has not reached a reduction limit value or image data has not reached a reduction limit value.

Step S1107: Judge Limit

If either one has not reached the reduction limit value at step S1106, the procedure branches to step S1108. However, if both text and images have reached the reduction limit values at step S1106, the procedure branches to step S1109.

Step S1108: Adjust Content Size

Size reduction of contents is made and rendering is repeated at step S1103 with reduced actual data again.

Step S1109: Adjust Rectangle Size and Generate Rectangle Layout Information

If contents do not fit in the rectangle area even after both images and text are rendered at reduction limit values, a size of rectangle area that can accommodate the contents is calculated, e.g., from the number of overflowing characters in text data. The calculated size of rectangle area is added as the reduction limit value to rectangle information and content data.xml (102) that is input from the input unit 103, and switch property is set ON as a flag for enabling the reduction limit values. In other words, at step S1109, the sizes of the rectangle areas (i.e., reduction limit values) that are required for containing the contents is determined corresponding to the contents. The determined sizes are then written in rectangle information and content data.xml (102) which describes a plurality of contents, with respect to the respective contents.

The updated rectangle information and content data is passed to rectangle layout process performed at step S104 as the size-limited rectangle information 111 shown in FIG. 2, where the rectangle areas are laid out in the layout area again. In other words, at step S104, the sizes of the rectangle areas corresponding to the respective contents are adjusted under condition of the determined sizes (or reduction limit values) such that the rectangle areas for the contents do not overlap. More specifically, the sizes of the rectangle areas for the respective contents described in rectangle information and content data.xml (102) are adjusted on condition of sizes that are written in rectangle information and content data.xml (102) with respect to the respective contents.

Step S1110: Generate Application Data

The final rendering result, that is, the final layout result 107 in the file 7 of FIG. 2, is converted to application data 112 such as in PDF. The processing at the rendering and ill-fitting information compiling process S108 is finished.

<A Concrete Example of the Final Layout Result>

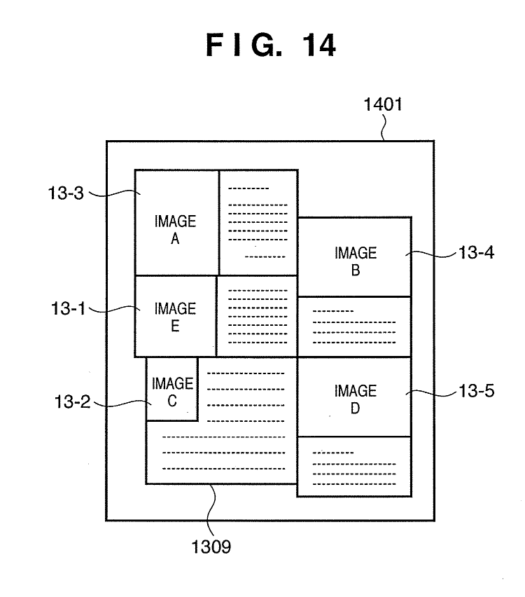

FIG. 14 illustrates an example 1401 of the final layout result when layout and rendering of rectangle areas has been completed in the specific example of the embodiment.

As text data overflows rectangle areas 13-2, 13-3 and 13-5 at 1302 in FIG. 13, text size is first reduced. As a result of reduction, text data can fit in rectangle areas 13-3 and 13-5. The size of the image is next reduced in the rectangle area 13-2 which still has overflowing contents. But, as the contents still does not fit in the rectangle area 13-2, a reduction limit value for the rectangle area 13-2 at which the contents can fit in the rectangle area 13-2 is set.

When the reduction limit value for the rectangle area 13-2 is set, the rectangle area 13-2 does not fit in the layout area under layout result 1301. FIG. 14 shows an example of the layout result, where the position of rectangle area 13-2 for which the reduction limit value is set has been changed with rectangle area 13-5 and positions of rectangle areas 13-3 and 13-4 have been moved so that all the rectangle areas fit in the layout area and contents can fit in the laid out rectangle areas.

As has thus been described in detail, according to the embodiment, combination of layout and rendering processes enables correction of ill-fitting rectangle areas caused when contents are rendered in the course of rendering process. That is, layout process is performed again with reflecting the ill-fitting information of rectangle areas in parameters necessary for layout process (e.g., rectangle size, text size and image size). By this processing, it is possible to obtain layout and rendering results that decide a more appropriate layout considering actual content data.

The present invention may be applied to a system that is composed of a plurality of devices (e.g., computers, interfacing devices, readers and printers) or a layout apparatus that is formed of a single device.

The object of the present invention can be also attained by inserting a storage medium that has stored therein a program code for realizing the procedures of the flowcharts shown in the above described embodiment into a system or an apparatus, and a computer (or a CPU or MPU) in the system or the apparatus reading out the program code stored in the storage medium and executing it.

In this case, the program code itself read out from the storage medium realizes the functions of the above described embodiment and the storage medium storing the program code constitutes the present invention.

The storage medium for supplying the program code may be a hard disk, optical disk, magneto-optical disk, CD-ROM, CD-R, magnetic tape, non-volatile memory card or ROM.

It is also contemplated that an operating system (OS) running on the computer performs some or all of actual processing based on instructions in the program code read by the computer so as to realize the functions of the above described embodiment.

The program code read from the storage medium is further written in a function extension board inserted into the computer and/or memory provided in a function extension unit connected to the computer. The functions of the above described embodiment may also be realized by a CPU provided in the function extension board or function extension unit subsequently performing some or all of actual processing based on instructions in the program code.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-328084, filed on Nov. 11, 2005, which is hereby incorporated by reference herein in its entirety.

What is claimed is:

1. A method of performing a layout of a plurality of contents, comprising the steps of:
determining sizes of areas respectively corresponding to respective contents of the plurality of contents, said sizes being required for accommodating the respective contents; and
performing a layout of the areas respectively corresponding to the respective contents,
wherein said layout step includes a step of adjusting the sizes of the areas corresponding to the respective contents under condition of the determined sizes so that the areas respectively corresponding to the respective contents do not overlap.

2. The method according to claim 1, wherein said layout step has a first layout step and a second layout step,
in said determining step, when the respective contents do not fit in the areas corresponding to the respective contents that have been laid out at the first layout step, the sizes of the areas that are required for accommodating the respective contents are determined, and
the second layout step includes a step of adjusting the sizes of the areas corresponding to the respective contents under condition of the determined sizes so that the areas respectively corresponding to the respective contents do not overlap.

3. The method according to claim 1, wherein in said determining step, the determined sizes are written, with respect to the respective contents, in a structured document in which the plurality of contents are described, and
in said adjustment step, the sizes of the areas respectively corresponding to the respective contents described in the structured document are adjusted under condition of sizes that are written in the structured document with respect to the respective contents in said determining step.

4. A layout apparatus for performing a layout of a plurality of contents, comprising:
determination means for determining sizes of areas respectively corresponding to respective contents of the plurality of contents, said sizes are required for accommodating the respective contents; and
layout means for performing a layout of the areas corresponding to the respective contents,
wherein said layout means adjusts the sizes of the areas respectively corresponding to the respective contents under condition of the determined sizes so that the areas corresponding to the respective contents do not overlap.

5. The apparatus according to claim 4, wherein said layout means executes a first layout and a second layout,
said determination means, when the respective contents do not fit in the areas respectively corresponding to the contents that have been laid out in the first layout by said layout means, determines the sizes of the areas that are required for accommodating the respective contents, and
said layout means, when executing the second layout, adjusts the sizes of the areas respectively corresponding to the respective contents under condition of the determined sizes so that the areas respectively corresponding to the respective contents do not overlap.

6. The apparatus according to claim 4, wherein said determination means writes the determined sizes, with respect to the respective contents, in a structured document in which the plurality of contents are described, and
said adjustment means adjusts the sizes of the areas respectively corresponding to the respective contents written in the structured document, under condition of sizes that are written in the structured document with respect to the respective contents by said determination means.

7. A computer-executable program for performing a layout of a plurality of contents, comprising the steps of:
determining sizes of areas respectively corresponding to respective contents of the plurality of contents, said sizes being required for accommodating the respective contents; and
performing a layout of the areas respectively corresponding to the respective contents,
wherein said layout step includes a step of adjusting the sizes of the areas corresponding to the respective contents under condition of the determined sizes so that the areas respectively corresponding to the respective contents do not overlap.

8. The program according to claim 7, wherein said layout step has a first layout step and a second layout step,
in said determining step, when the respective contents do not fit in the areas corresponding to the respective contents that have been laid out at the first layout step, the sizes of the areas that are required for accommodating the respective contents are determined, and
the second layout step includes a step of adjusting the sizes of the areas corresponding to the respective contents under condition of the determined sizes so that the areas respectively corresponding to the respective contents do not overlap.

9. The program according to claim 7, wherein in said determining step, the determined sizes are written, with respect to the respective contents, in a structured document in which the plurality of contents are described, and
in said adjustment step, the sizes of the areas respectively corresponding to the respective contents described in the structured document are adjusted under condition of sizes that are written in the structured document with respect to the respective contents in said determining step.
